(19) United States
(12) Patent Application Publication
(10) Pub. No.: US 2025/0208295 A1
(43) Pub. Date: Jun. 26, 2025

(54) DEVICE ENABLING DATA TRANSMISSION AND SYNCHRONIZATION OF DEPTH DATA, RGB DATA WITH THE REAL TIME AND METHOD THEREOF

(71) Applicant: E-CON SYSTEMS INDIA PRIVATE LIMITED., Tamilnadu (IN)

(72) Inventor: PRABU KUMAR KESAVAN, Tamil Nadu (IN)

(21) Appl. No.: 18/395,032

(22) Filed: Dec. 22, 2023

(51) Int. Cl. G01S 17/894; G01S 7/484

(52) U.S. Cl. CPC G01S 17/894; G01S 7/484

(57) ABSTRACT

The invention discloses a device enabling data transmission in a network communication. The device comprises a plurality of sensors and a processor. Each sensor from the plurality of sensors is configured for sensing the data in a predefined area. The processor in the device further comprises an encoder and a transmitter. The processor is configured to strip a first line of data from the predefined data received from the sensors and combine strip data to obtain a combined data stream. The encoder is configured to generate an output data stream by using the combined data stream. The transmitter is configured for transmitting the output data stream to a host processor for reconstructing an image form the output data stream.

### TECHNICAL FIELD

The present invention relates to a field of embedded camera. More particularly, the present invention relates to synchronization of depth data, RGB data with the real time.

### BACKGROUND OF THE INVENTION

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

A time-of-flight camera, often referred to as a ToF camera or time-of-flight sensor, constitutes a range imaging camera system designed to measure distances between the camera and the subject for every point within the image by leveraging the principle of time-of-flight. This involves the transmission of light pulses, or in some cases, a single light pulse. The operational principle of Time of Flight (ToF) cameras is the emission of a light source and the subsequent reception of the reflected light. By calculating the depth through the analysis of reflected light intensity and the time required for the light to travel back to the camera, ToF cameras facilitate accurate distance measurements.

The utilization of ToF sensors, owing to their straightforward functionality and efficient extraction of distance information, spreads across diverse applications. Such application of the ToF sensors include human-machine interfaces, gaming, smartphone cameras, robotics, earth topography, 3D measurement, and machine vision and similar applications. Time-of-Flight (ToF) cameras emerge as compelling embedded vision solutions, offering real-time depth measurements, particularly beneficial for tasks requiring autonomous and guided navigation.

In conventional ToF sensor applications, a processing system is integrated to handle the data acquired from the sensors. Some applications optimize system efficiency by pre-processing the data before transmission in the ToF camera, aiming to minimize latency.

It is one of the essential requirements of the TOF camera to process the data faster, transmit the processed data to the processor to take the necessary action. For instance, Time-of-flight cameras are used in assistance and safety functions for advanced automotive applications such as active pedestrian safety, precrash detection and indoor applications like out-of-position (OOP) detection. It is essential to process and synchronize the data from TOF, RGB and IMU and transmit the data faster so that the system can respond to event observed from the TOF sensor and the pre-crash detection earlier.

The TOF sensor may have many practical applications, and one of such example is an application in railway transportation. The TOF sensor may be integrated into an automation device, such as a robot, to efficiently detect the movement along the tracks. The automated device may be configured to monitor factors like tilt, inclination, and acceleration, promptly identifying events and sending alerts to the driver as needed. For effective implementation in this context, it is crucial for the TOF camera to swiftly process data, transmit the processed information to the processor, and take necessary actions in response.

### SUMMARY OF THE INVENTION

According to the main aspect of the present invention, the invention discloses a device enabling data transmission in a network communication comprising a plurality of sensors and a processor. The plurality of sensors are configured for sensing the data in a predefined area. The processor is configured for receiving, data sensed by each sensor of the plurality of sensors, stripping, through the processor, a predefined data from the data received from each of the sensor, combining, through an encoder each of the predefined data striped from the data received from each of the sensor for obtaining a combined data stream and, generating, through the encoder, an output data stream by using the combined data stream.

In one embodiment, the first sensor of the plurality of sensors comprises a Time-of-flight (ToF) sensor, a second sensor of the plurality of sensors comprise a Red Green Blue (RGB) image sensor and a third sensor of the plurality of sensors comprise an Inertial Measurement Unit (IMU) sensor.

In another embodiment, the data comprises a depth data sensed by a first sensor of the plurality of sensors, an image data sensed by a second sensor of the plurality of sensors and, an acceleration and angular velocity data by a third sensor of the plurality of sensors.

In another embodiment, the stripping the data comprises, stripping a first line of data as the predefined data from the data received from the first sensor comprising a Time-of-flight (ToF) sensor, stripping a first line of data as the predefined data from the data received from a second sensor comprising a Red Green Blue (RGB) image sensor, and stripping a first line of data as the predefined data from the data received from a third sensor comprising an Inertial Measurement Unit (IMU) sensor.

In another embodiment, the combining the data comprises, appending the predefined data from a second sensor comprising a Red Green Blue (RGB) image sensor and the predefined data from a third sensor comprising an IMU sensor to the predefined data from a first sensor comprising a ToF sensor for obtaining the combined data stream. Further, an encoder configured for encoding the output data stream before transmission, and a transmitter configured for transmitting the output data stream to a host processor for reconstructing an image from the output data. The device comprises an electronic device for example, a Time-of-Flight (ToF) camera.

According to another main aspect of the present invention a method for enabling data transmission in a network communication comprising, sensing through each sensor from a plurality of sensors which is data in a predefined area, receiving through a processor the data from each sensor of the plurality of sensors, stripping through the processor in a predefined data from the data received from each of the sensor, combining through an encoder each of the predefined data striped from the data received from each of the sensor for obtaining a combined data stream, and generating through the encoder an output data stream by using the combined data stream.

### BRIEF DESCRIPTION OF THE DRAWINGS

The invention will now be described in relation to the accompanying drawings in which,

FIG. 1 illustrates a block diagram of the device according to some embodiments of the present invention;

FIG. 2 illustrates a flowchart illustrating example method steps of a method performed by a device according to some embodiments of the present invention;

FIG. 3 illustrates additional details of the method, according to some embodiments of the present invention;

FIG. 4 illustrates additional details of the method, according to some embodiments of the present invention;

FIG. 5a illustrates an implementation of a device in a peer-to-peer communication, according to some embodiments of the present invention; and

FIG. 5b illustrates a network implementation of the device enabling data communication in a network communication, according to some embodiments of the invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The present invention provides a device (herein among a plurality of communication devices) for enabling data transmission in peer-to-peer communication or a network communication. The device receives and processes the data to strip and combine data received from multiple sensors for obtaining a combined data stream. The obtained data stream is transmitted to a system or a host machine. In this manner, the above-mentioned electronic device 100 reduces processing load on the system or the host machine.

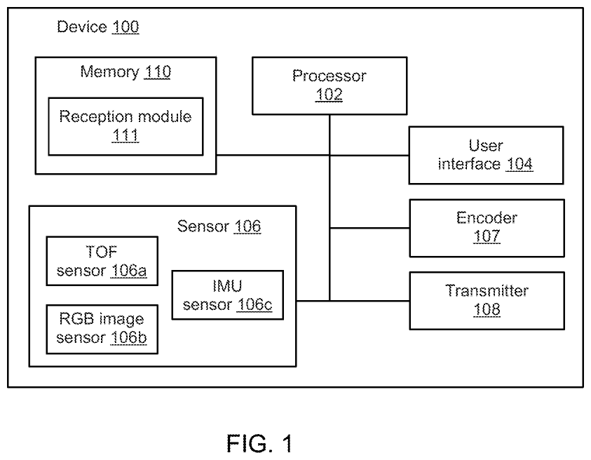

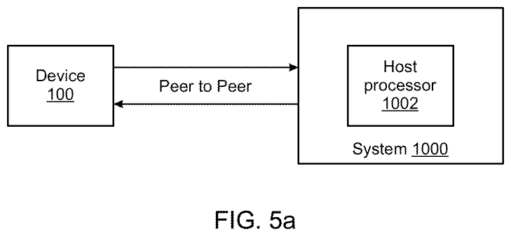

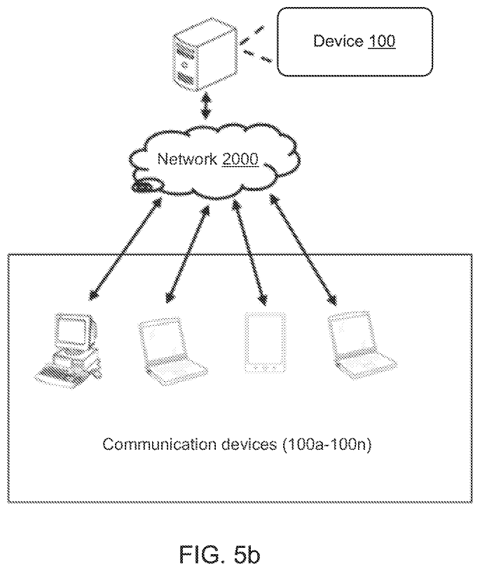

FIG. 1 is an example schematic diagram showing component details of a device 100. The device 100 is capable of emission of a light source through a light emitting means (not shown in Figure) and the subsequent reception of the reflected light through plurality of sensors 106. The device 100 is further capable of processing the data to obtain a data stream and transmit the data stream to a system 1000 or a host machine/processor 1002 (shown later in FIG. 5a). According to at least some embodiments of the present invention, the device 100 in FIG. 1 comprises a processor 102, a user interface 104, a plurality of sensors 106, an encoder 107, a transmitter 108, and a memory 110 storing a reception module 111 along with one or more modules executed by the processor 102.

The processor 102 is configured to execute the reception module 111. The memory 110 may also serve as a repository for storing data processed, received, and generated by reception module 111. The memory 110 may include data generated as a result of the execution of the reception module 111. The memory 110 may include any computer-readable medium or computer program product known in the art including, for example, volatile memory, such as Static Random-Access Memory, SRAM, and Dynamic Random-Access Memory, DRAM, and/or non-volatile memory, such as Read Only Memory, ROM, Erasable Programmable ROM, EPROM, Electrically Erasable and Programmable ROM, EEPROM, flash memories, hard disks, optical disks, and magnetic tapes.

The user interface 104 may include a variety of software and hardware interfaces, for example, a web interface, a graphical user interface, a command line interface, and the like. The user interface 104 may allow interaction with the device 100. The user interface 104 may facilitate multiple communications within a wide variety of networks and protocol types, including wired networks, for example, LAN, cable, etc., and wireless networks, such as WLAN, cellular, or satellite to establish the communication between the device 100 and the plurality of communication devices (100a-100n).

The device 100 comprises plurality of sensors 106, a first sensor of the plurality of sensors 106 comprises a Time-of-flight (ToF) sensor 106a, a second sensor of the plurality of sensors 106 comprise a Red Green Blue (RGB) image sensor 106b and wherein a third sensor of the plurality of sensors 106 comprise an Inertial Measurement Unit (IMU) sensor 106c. The sensor 106 may be any sensor, but not limited to, a Time-of-flight (ToF) sensor, a Red Green Blue (RGB) image sensor or an Inertial Measurement Unit (IMU) sensor.

According to the present invention each sensor (106a, 106b, and 106c) from the plurality of sensors 106 are configured for sensing the data in a predefined area. The data comprises a depth data sensed by a first sensor 106a of the plurality of sensors 106, an image data sensed by a second sensor 106b of the plurality of sensors 106 and, an acceleration and angular velocity data sensed by a third sensor 106c of the plurality of sensors 106. The processor 102 is configured for receiving, the data sensed by each sensor (106a, 106b, and 106c) of the plurality of sensors 106. The processor 102 further comprises the encoder 107 for stripping a predefined data from the data received from each of the sensor 106.

The processor 102 is further configured to combine each of the predefined data striped from the data received from each of the sensor (106a, 106b, and 106c) for obtaining a combined data stream. The combination is performed through an encoder 107. The encoder 107 is then configured to generate an output data stream by using the combined data stream.

According to the main aspect of the present invention, the encoder 107 is configured for stripping a first line of data as the predefined data from the data received from the first sensor 106a comprising a Time-of-flight (ToF) sensor a first line of data as the predefined data from the data received from a second sensor 106b comprising a Red Green Blue (RGB) image sensor, and a first line of data as the predefined data from the data received from a third sensor 106c comprising an Inertial Measurement Unit (IMU) sensor.

Further, the encoder 107 combines the data by appending the predefined data from the Red Green Blue (RGB) image sensor and the predefined data from the IMU sensor to the predefined data from the ToF sensor for obtaining the combined data stream. The encoder 107 is further configured to generate the output data stream by using the combined data stream.

The processor 102 further comprises the transmitter 108 which is configured for transmitting the output data stream to a host processor 1002 for reconstructing an image form the output data stream.

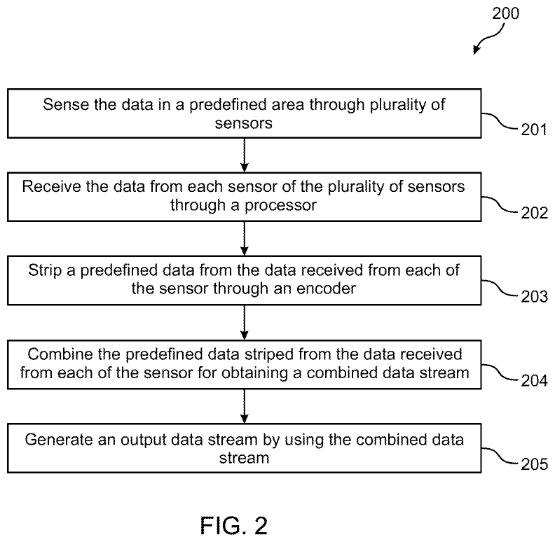

FIG. 2 provides a flowchart illustrating example method steps of a method 200 executed through the device 100.

At step 201, the method 200 comprises sensing data in the predefined area using the plurality of sensors 106. The data comprises the depth data sensed by the first sensor 106a of the plurality of sensors 106, the image data sensed by the second sensor 106b of the plurality of sensors and, the acceleration and angular velocity data sensed by the third sensor 106c of the plurality of sensors 106.

At step 202, the method 200 comprises, receiving the data from each sensor of the plurality of sensors 106. The data is received by the processor 102.

At step 203, the method 200 comprises, stripping the predefined data from the data received from each of the sensor 106 by using the encoder 107. Stripping: the first line of data as the predefined data from the Time-of-flight (ToF) sensor 106a, the first line of data as the predefined data from the Red Green Blue (RGB) image sensor 106b, and the first line of data as the predefined data from the Inertial Measurement Unit (IMU) sensor 106c.

At step 204, the method 200 comprises, combining the predefined data striped from the data received from each of the sensor (106a, 106b, and 106c) for obtaining the combined data stream. The combining the data comprises of appending predefined data from the Red Green Blue (RGB) image sensor 106b and the predefined data from the IMU sensor 106c to the predefined data from the ToF sensor 106a for obtaining the combined data stream.

At step 205, the method 200 comprises, generating the output data stream by using the combined data stream.

Optionally, the method 200 further comprises transmitting the output data stream of the device 100 to the host processor 1002 for reconstructing an image form the output data stream. The output data stream may be transmitted through the transmitter 108.

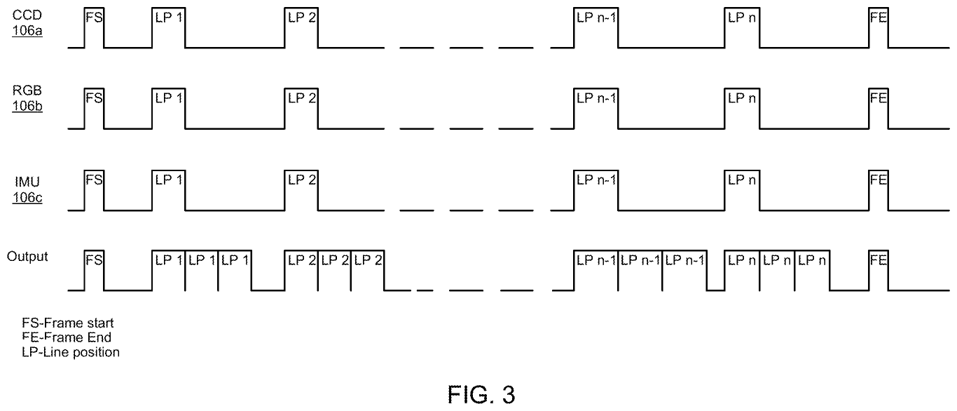

In an exemplary embodiment, FIG. 3 illustrates a process of combining of data by the device 100. As shown in FIG. 3, the data from the Time-of-Flight (ToF) camera sensor (CCD) 106a (i.e., first sensor 106a), a Red Green Blue (RGB) image sensor 106b (i.e., second sensor 106b) and an Inertial Measurement Unit (IMU) sensor 106c (i.e., third sensor) is shown. Each data having a Line Position (LP) varies between LP (n) to LP (n−1) in a frequency bandwidth from Frame Start (FS) to Frame End (FE).

The processor 102 of the device 100, strips the data which is the first line data of first sensor 106a (i.e., LP1 of first sensor 106a), first line of data of the second sensor 106b (i.e., LP1 of second sensor 106b) and first line of data of the third sensor (i.e., LP1 of third sensor 106c). Further, the encoder 107 combines the predefined data strip by appending the first line of data from the second sensor 106b and the first line of data from the third sensor 106c to the first line of data from the first sensor 106a to obtain combined data output stream. Similarly, the encoder 107 of the device 100 processes the data for all “n^{th}” number of Line Position (LPn) of the predefined data for synchronization.

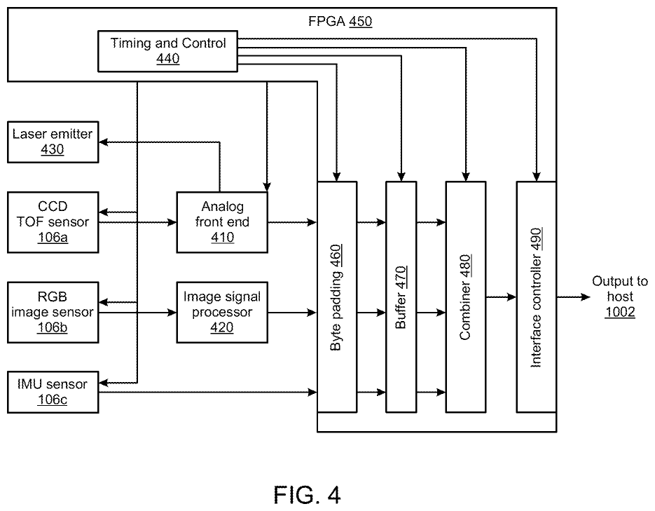

FIG. 4 illustrates the example of data synchronization in a system 1000 according to the present invention. The device 100 comprises a laser emitter for emitting light which is reflected and received by each of the Time-of-Flight (ToF) camera sensor (CCD) 106a, the Red Green Blue (RGB) image sensor 106b, and the Inertial Measurement Unit (IMU) sensor 106c.

In an embodiment plurality of devices such as a Field-Programmable Gate Array [FPGA] 450, a laser emitter 401, a CCD TOF sensor 106a, an RGB image sensor 106b, an IMU sensor 106c, an Analog Front End control 410, an Image signal processor 420, a byte padding 460, a buffer 470, combiner 480, and an Interface controller 490.

In an example in the device 100 may comprise a direct time-of-flight camera (ToF) system, where the laser emitter 430 is synchronized with a detector to provide the time-of-flight measurements per the emission-detection intervals. The time-of-flight measurements are translated to distance using the speed of light as a universal constant. The laser emitter 430 in the ToF camera system is essential for generating the light pulses that enable accurate distance measurements.

A ToF sensor 106a uses Time-of-Flight to measure depth and distance. Any camera equipped with a ToF sensor 106a measures distance by actively illuminating an object with a modulated light source (such as a laser or an LED) 430. The camera uses a sensor that is sensitive to a laser's wavelength (typically 850 nm or 940 nm) to capture the reflected light.

Three sensors (106a, 106b, 106c), timing and control circuit 440 implemented in the FPGA 450 which is used to control entire signal flow and operation of the device 100. In addition to timing and control circuit 440, byte padding 460, buffer 470, combiner 480, and interface controller 490 blocks are also present.

The system requires the AFE (Analog front end control) 410 which can digitize and output the depth data. The Analog front end controls 410 the operation of the laser emitter 430 which is triggered by the timing and control circuit. The AFE 410 has got dedicated processing circuit to drive the laser emitter 430, receive TOF sensor data, extract the distance data from the TOF sensor 106a.

The RGB sensor 106b is triggered by a signal from timing and control circuit, on receiving signal, RGB sends first line of data.

The Image signal processor 420 correct the image irregularities, white balancing, blur, distortion etc. produce usable image output.

The Byte padding 460 block receives three inputs, line data of TOF, RGB, IMU, which are different. Adding dummy bits to the received input from the three sensors to make predefined output data.

The Buffer 470 is used for managing the response time to receive all data. The buffer 470 is also used to store incoming data until it can be effectively processed or transmitted.

Interface controller 490 either USB or Mipi is used depending on the specific application. For USB, controllers manage the communication between devices as per the USB standard. Similarly, for MIPI interfaces, controllers designed to handle the specific MIPI protocols, such as MIPI CSI-2 controllers for cameras.

In an exemplary embodiment, the combiner 480 operates at three times the frame rate of the plurality of sensor 106 such as CCD TOF sensor 106a, RGB image sensor 106b, IMU sensor 106c. With the proposed device 100 and the method 200, time lag is minimal, and there is a reduction in latency. The device 100 is primarily configured for sending first line of data as the predefined data. In an embodiment a Region of interest may be selected and sent as combined output along with the predefined data.

In an exemplary embodiment, FIG. 5 (a) discloses an implementation of the device 100 in a peer-to-peer communication. FIG. 1 (a) discloses the device 100 and a system 1000 having the host processor 1002 or the host machine 1002 in the peer-to-peer communication. The data received by the device 100 is processed and the data stream generated by the device 100 is transmitted to the host machine 1002 of the system 1000.

FIG. 5 (b) discloses another embodiment of the present invention wherein it discloses a network implementation of the device 100 and a plurality of communication devices (100a-100n) configured to communicate with each other via a network 2000. The network communication system further includes a server connected to the device 100. The server may be further connected to the plurality of communication devices (100a-100n) through the network 2000.

It should be understood that the server, the device 100, and the plurality of communication devices (100a-100n) corresponds to computing devices. It may be understood that the server may also be implemented in a variety of computing systems such as, a laptop computer, a desktop computer, a notebook, a workstation, a mainframe computer, a network server, a cloud-based computing environment, or a smart phone, and the like. It may be understood that the system may correspond to a variety of portable computing devices such as, a laptop computer, a desktop computer, a notebook, a smart phone, a tablet, a phablet, and the like. Further, it may be understood that the device 100 may be, but not limited to, a camera, specifically an Ethernet camera.

In an example implementation, the network 2000 may be a wireless network, a wired network, or a combination thereof. The network 2000 can be implemented as one of the different types of networks, such as intranet, Local Area Network, LAN, Wireless Personal Area Network, WPAN, Wireless Local Area Network, WLAN, wide area network, WAN, the Internet, and the like. The network 2000 may either be a dedicated network or a shared network. The shared network represents an association of the different types of networks that use a variety of protocols, for example, MQ Telemetry Transport, MQTT, Extensible Messaging and Presence Protocol, XMPP, Hypertext Transfer Protocol, HTTP, Transmission Control Protocol/Internet Protocol, TCP/IP, Wireless Application Protocol, WAP, and the like, to communicate with one another. Further, the communication network 2000 may include a variety of network devices, including routers, bridges, servers, computing devices, storage devices, and the like.

In accordance with embodiments disclosed herein, the server is configured for establishing the communication between the device 100 and the plurality of communication devices 100a-100n.

With the proposed embodiment, the present device 100 and the method 200 offers an advantage by optimizing the device 100 to efficiently decrease the duration required for capturing and processing acquired data, thereby minimizing latency. Additionally, the proposed device 100 and the method 200 removes the necessity for executing data processing tasks on the host processor 1002. The enhancement of the present invention not only reduces the computational power required, but also reduces time overheads and mitigates losses caused by interference. The overall effect is a significant enhancement in the accuracy of the device 100.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope of the present invention.

What is claimed is:

1. A device enabling data transmission in a network communication, the device comprising:
a plurality of sensors, wherein each sensor from the plurality of sensors is configured for sensing the data in a predefined area;
a processor configured for:
receiving, data sensed by each sensor of the plurality of sensors;
stripping, a predefined data from the data received from each of the sensor;
combining, through an encoder each of the predefined data striped from the data received from each of the sensor for obtaining a combined data stream; and
generating, through the encoder, an output data stream by using the combined data stream.

2. The device as claimed in claim 1, wherein the first sensor of the plurality of sensors comprise a Time-of-flight (ToF) sensor, a second sensor of the plurality of sensors comprise a Red Green Blue (RGB) image sensor and wherein a third sensor of the plurality of sensors comprise an Inertial Measurement Unit (IMU) sensor.

3. The device as claimed in claim 1, wherein the data comprises a depth data sensed by a first sensor of the plurality of sensors, an image data sensed by a second sensor of the plurality of sensors and, an acceleration and angular velocity data by a third sensor of the plurality of sensors.

4. The device as claimed in claim 1, wherein the stripping the data comprises:
stripping, a first line of data as the predefined data from the data received from the first sensor comprising a Time-of-flight (ToF) sensor;
stripping, a first line of data as the predefined data from the data received from a second sensor comprising a Red Green Blue (RGB) image sensor; and
stripping, a first line of data as the predefined data from the data received from a third sensor comprising an Inertial Measurement Unit (IMU) sensor.

5. The device as claimed in claim 1, wherein the combining the data comprises:
appending, the predefined data from a second sensor comprising a Red Green Blue (RGB) image sensor and the predefined data from a third sensor comprising an IMU sensor to the predefined data from a first sensor comprising a ToF sensor for obtaining the combined data stream.

6. The device as claimed in claim 1, comprising:
an encoder configured for encoding the output data stream before transmission.

7. The device as claimed in claim 1, comprising:
a transmitter configured for transmitting the output data stream to a host processor for reconstructing an image from the output data.

8. The device as claimed in claim 1, wherein the device comprises an electronic device comprising a Time-of-Flight (ToF) camera.

9. A method enabling data transmission in a network communication, the method comprising:
sensing, through each sensor from a plurality of sensors, data in a predefined area;
receiving, through a processor, the data from each sensor of the plurality of sensors,
stripping, the processor, a predefined data from the data received from each of the sensor;
combining, through an encoder each of the predefined data striped from the data received from each of the sensor for obtaining a combined data stream; and
generating, through the encoder, an output data stream by using the combined data stream.

10. The method as claimed in claim 9, wherein the first sensor of the plurality of sensors comprise a Time-of-flight (ToF) sensor, a second sensor of the plurality of sensors comprise a Red Green Blue (RGB) image sensor and wherein a third sensor of the plurality of sensors comprise an Inertial Measurement Unit (IMU) sensor.

11. The method as claimed in claim 9, wherein the data comprises a depth data sensed by a first sensor of the plurality of sensors, an image data sensed by a second sensor of the plurality of sensors and, an acceleration and angular velocity data by a third sensor of the plurality of sensors.

12. The method as claimed in claim 9, wherein the stripping the data comprises:
stripping, a first line of data as the predefined data from the data received from the first sensor comprising a Time-of-flight (ToF) sensor;
stripping, a first line of data as the predefined data from the data received from a second sensor comprising a Red Green Blue (RGB) image sensor; and
stripping, a first line of data as the predefined data from the data received from a third sensor comprising an Inertial Measurement Unit (IMU) sensor.

13. The method as claimed in claim 9, wherein the combining the data comprises:
appending, the predefined data from a second sensor comprising a Red Green Blue (RGB) image sensor and the predefined data from a third sensor comprising an IMU sensor to the predefined data from a first sensor comprising a ToF sensor for obtaining the combined data stream.

14. The method as claimed in claim 9, comprising:
encoding, through the encoder, the output data stream before transmission.

15. The method as claimed in claim 9, comprising:
transmitting, through a transmitter, the output data stream to a host processor for reconstructing an image from the output data.
